(19) United States
(12) Patent Application Publication
(10) Pub. No.: US 2026/0078229 A1
(43) Pub. Date: Mar. 19, 2026

(54) METHOD FOR MANUFACTURING SILICON CONTAINING CONFORMAL CURED FILM

(71) Applicant: Merck Patent GmbH, Darmstadt (DE)

(72) Inventor: Issei Sakurai, Shizuoka (JP)

(21) Appl. No.: 19/398,500

(22) Filed: Nov. 24, 2025

Related U.S. Application Data
(63) Continuation of application No. PCT/EP2024/064198, filed on May 23, 2024.

(30) Foreign Application Priority Data
May 25, 2023 (JP) 2023-086318

(51) Int. Cl. C08J 5/18; C09D 183/08

(52) U.S. Cl. CPC C08J 5/18; C09D 183/08; C08J 2383/08

(57) ABSTRACT

A method for manufacturing a silicon containing conformal cured film includes: (a) applying to a substrate a cured film forming composition that includes a silicon containing polymer (I) and a solvent (II); (b) forming a conformal film by drying the composition; and (c) curing the conformal film by heating the substrate and/or irradiating the substrate with energy rays. The solvent (II) includes a solvent (II-A) with a relative evaporation rate S1 and a solvent (II-B) with a relative evaporation rate S2; wherein S1>S2; and S1/S2 is in the range from 3.0 to 35.0.

### CROSS-REFERENCE TO RELATED APPLICATIONS

This application is a Continuation under 35 USC § 111 (a) of International Patent Application No. PCT/EP2024/064198 filed May 23, 2024, which claims priority to Japanese Patent Application No. 2023-086318 filed May 25, 2023. The entire contents of these applications are incorporated herein by reference in their entirety.

### BACKGROUND OF THE INVENTION

### Technical Field

The present invention relates to a method for manufacturing a silicon containing conformal cured film.

### Background Art

In the manufacturing of electronic devices, typically semiconductor devices, interlayer insulating films are formed between transistor elements and bit lines, between bit lines and capacitors, between capacitors and metal wiring, and between multiple metal wirings, etc. Furthermore, an insulating material may be embedded in isolation trenches formed on the substrate surface and the like. A siliceous film is often used as such an insulating film.

For the method for forming a siliceous film, a chemical vapor deposition method (CVD), an atomic layer deposition method (ALD), and a method in which a liquid composition comprising a silicon containing polymer is applied and baked (SOD: Spin on dielectric) are sometimes individually used.

When using CVD or ALD, a conformal siliceous film tends to be formed, but the equipment thereof is expensive and the formation thereof takes time.

SOD is suitably used for filling narrow trenches and planarizing, and because it is a simple process, there are fewer restrictions on equipment and high throughput can be expected. On the other hand, it is difficult to form a conformal film that follows the irregularities of the substrate with SOD.

There is a need for a method to form a conformal film using the SOD process. For example, a method for forming a conformal film using a composition comprising siloxane resin has been disclosed in WO 2012/136892.

### SUMMARY OF THE INVENTION

### Problems to be Solved by the Invention

The present inventors thought that there are one or more problems that still require improvement in methods for manufacturing a silicon containing cured film. Examples of such problems include: a highly conformal cured film is not formed; a cured film is not formed on the sides of a trench; the trench is filled with the cured film; the manufacturing process is complicated; and the manufacturing takes a long time.

### Means for Solving the Problems

A method for manufacturing a silicon containing conformal cured film according to the present invention comprises the following steps;
(a) applying a cured film forming composition comprising a silicon containing polymer (I) and a solvent (II) to a substrate;
(b) forming a conformal film by drying the composition; and
(c) curing the conformal film by heating the substrate and/or irradiating the substrate with energy rays;
wherein the solvent (II) comprises a solvent (II-A) with a relative evaporation rate S1 and a solvent (II-B) with a relative evaporation rate S2;
wherein S1>S2; and
S1/S2 is in the range from 3.0 to 35.0, provided that the evaporation rate of n-butyl acetate measured at 25° C. and 1 atm according to ASTM-D3539 is 1.

The silicon containing conformal cured film according to the present invention is manufactured by the above method.

The method for manufacturing an element of an electronic device according to the present invention comprises the above method.

### Effects of the Invention

According to the present invention, one or more of the following effects can be desired:

A cured film with sufficient high conformality is formed; the cured film is formed also on the sides even in a narrow trench; the trench is not filled even in the narrow trench; the cured film is formed in a sufficiently simple process; and the cured film can be formed in a sufficiently short time.

### BRIEF DESCRIPTION OF THE DRAWINGS

FIG. 1 is a schematic illustration showing the state in which a conformal film is formed in a trench.

FIG. 2 is an electron micrograph showing the state in which a highly conformal cured film is formed.

FIG. 3 is an electron micrograph showing the state in which no cured film is formed on the sides of a trench.

FIG. 4 is an electron micrograph showing the state in which a trench is filled with a cured film.

### DETAILED DESCRIPTION OF THE INVENTION

### Mode for Carrying Out the Invention

### Definitions

Unless otherwise specified in the present specification, the definitions and examples described below are followed.

The singular form includes the plural form and “one” or “that” means “at least one”. An element of a concept can be expressed by a plurality of species, and when the amount (for example, mass % or mol %) is described, it means sum of the plurality of species.

“And/or” includes a combination of all elements and also includes single use of the element.

When a numerical range is indicated using “to” or “-”, it includes both endpoints and units thereof are common. For example, 5 to 25 mol % means 5 mol % or more and 25 mol % or less.

Alkyl means a group obtained by removing any one hydrogen from a linear, branched or cyclic saturated hydrocarbon and includes a linear alkyl, branched alkyl or cycloalkyl and optionally includes a linear or branched alkyl in the cyclic structure as a side chain. Aryl means a group obtained by removing any one hydrogen from an aromatic hydrocarbon.

The descriptions such as “C_{x-y}”, “Cₓ-C_{y}” and “Cₓ” mean the number of carbons in a molecule or substituent. For example, C₁₋₆ alkyl means an alkyl chain having 1 or more and 6 or less carbons (methyl, ethyl, propyl, butyl, pentyl, hexyl etc.).

When a polymer has plural types of repeating units, these repeating units may copolymerize. Such copolymerizations can be any of alternating copolymerization, random copolymerization, block copolymerization, graft copolymerization, or a mixture thereof. When polymer or resin is represented by a structural formula, n, m or the like that is attached next to parentheses indicate the number of repetitions.

Celsius is used as the temperature unit. For example, 20 degrees means 20 degrees Celsius.

The additive refers to a compound itself having a function thereof (for example, in the case of a base generator, a compound itself that generates a base). An embodiment in which the compound is dissolved or dispersed in a solvent and added to a composition is also possible. As one embodiment of the present invention, it is preferable that such a solvent is contained in the composition according to the present invention as the solvent or another component.

Hereinafter, embodiments of the present invention are described in detail.

### Method for Manufacturing Silicon Containing Conformal Cured Film

The method for manufacturing a silicon containing conformal cured film according to the present invention comprises the following steps;
(a) applying a cured film forming composition comprising a silicon containing polymer (I) and a solvent (II) to a substrate;
(b) forming a conformal film by drying the composition; and
(c) curing the conformal film by heating the substrate and/or irradiating the substrate with energy rays;
wherein the solvent (II) comprises a solvent (II-A) with a relative evaporation rate S1 and a solvent (II-B) with a relative evaporation rate S2;
wherein S1>S2; and
S1/S2 is in the range from 3.0 to 35.0, provided that the evaporation rate of n-butyl acetate measured at 25° C. and 1 atm according to ASTM-D3539 is 1.

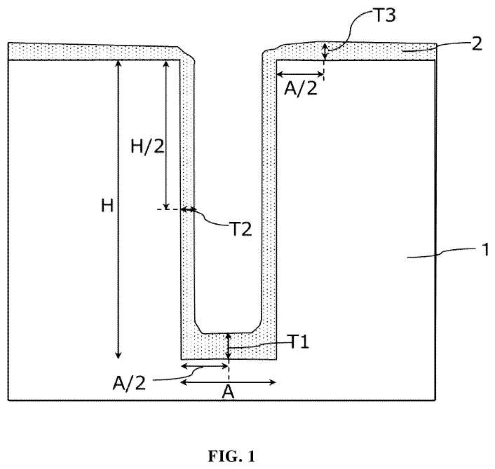

In the present invention, the conformal film (or cured film) means that the trench is not filled with a cured film and formation of any film is not recognized on the sides of the trench when a substrate has a trench so that the film is formed continuously. FIG. 1 is a schematic illustration in which a conformal film 2 is formed using a substrate 1 having a trench with an opening width A and a depth H. At this time, the trench bottom film thickness T1 at the center of the trench is preferably 5 nm or more and H/3 or less, more preferably 5 nm or more and H/4 or less, and the trench side film thickness T2 at the position of depth H/2 is preferably 5 nm or more and A/3 or less, more preferably 5 nm or more and A/4 or less, and the substrate upper surface film thickness T3 at the position A/2 from the opening is preferably 5 nm or more and A/2 or less, more preferably 5 nm or more and A/3 or less.

The substrate may have a convex portion. In that case, a film is continuously formed on the top and side surfaces of the convex shape. The film does not flatten against the convex portion but follows it to be formed.

In the present invention, the highly conformal film means one that has sufficient high followability to the substrate, sufficient high film thickness uniformity, a sufficiently large T3/T1 ratio and a sufficiently small dependence in the depth direction of T2.

### Step (a)

The step (a) is a step of applying a cured film forming composition (hereinafter sometimes referred to as the composition) comprising a silicon containing polymer (I) and a solvent (II) to a substrate.

In the present invention, the substrate may be a single layer or a laminate. Although the shape of the trench is not particularly limited, since the present invention is characterized in that a conformal cured film can be formed even in a narrow and long trench or the like, a substrate having trenches or holes with a high aspect ratio is preferable. The aspect ratio is preferably in the range from 5 to 100, more preferably in the range from 10 to 100. There is no particular limitation on the shape of the trench, and cross section thereof may be any shape such as a rectangular, a forward tapered shape, a reverse tapered shape, or a curved surface shape. Further, both end portions of the trench may be opened or closed.

Examples of the substrate include substrates for electronic devices comprising transistor elements, bit lines, capacitors, and the like.

The cured film forming composition may be applied to the substrate directly or via one or more interlayers. There is no particular restriction on the method for applying to the substrate, and it includes usual coating methods such as spin coating, dipping, spraying, transferring, and slit coating.

The preferable cured film forming composition is described later.

### Step (b)

The step (b) is a step of forming a conformal film by drying the cured film forming composition applied to the substrate.

Drying can be performed by combining spin drying, reduced pressure, heating (prebaking), etc. Drying is preferably performed by heating after spin drying or by heating after reducing pressure.

Preferably, spin drying is performed for 30 to 180 seconds at a higher rotational speed than that during spin coating.

It is preferable to reduce the pressure at 100 to 400 Pa for 1 to 10 minutes.

Heating (prebaking) is performed, for example, on a hot plate, the heating temperature is preferably in the range from 80 to 250° C., more preferably in the range from 100 to 250° C., and the heating time is preferably in the range from 30 to 600 seconds, more preferably in the range from 60 to 500 seconds. Prebaking is preferably performed under a nitrogen atmosphere.

### Step (c)

The step (c) is a step of curing the conformal film by heating the substrate and/or irradiating the substrate with energy rays, preferably by heating.

In the case of heating, the temperature is not particularly limited as long as it cures the conformal film. In order to accelerate the curing reaction and obtain a sufficiently cured film, the curing temperature is preferably in the range from 300 to 1,000° C., more preferably in the range from 300 to 800° C. The heating time is not particularly limited, and is preferably in the range from 1 minute to 10 hours, more preferably in the range from 1 to 180 minutes. The atmosphere during curing varies depending on the type of silicon containing polymer, but is preferably a steam atmosphere or a nitrogen atmosphere, more preferably a steam atmosphere.

In the case of energy ray irradiation, a ray, y ray, electron beam, X ray, ultraviolet ray, visible light, infrared light, and the like can be used as the energy ray. The peak wavelength of the energy ray is preferably in the range from 100 to 250 nm, more preferably in the range from 120 to 250 nm. The energy ray irradiation amount is preferably in the range from 4 to 80 J/cm², more preferably in the range from 8 to 80 J/cm².

The curing step can also be divided into two or more stages. For example, first heating is carried out at a low temperature (for example, temperature in the range from 300 to 600° C.) in an atmosphere containing steam, and then heating (annealing) can be carried out at a higher temperature (for example, 600 to 1,000° C.) in an atmosphere free of steam, preferably a nitrogen atmosphere.

The silicon containing conformal cured film according to the present invention can be obtained by the method described above.

The refractive index of the silicon containing conformal cured film for light with a wavelength of 633 nm is preferably in the range from 1.40 to 2.20, more preferably in the range from 1.42 to 2.20.

The method for manufacturing an electronic device according to the present invention comprises the above method. The electronic device is preferably a semiconductor device.

### Cured Film Forming Composition

The cured film forming composition (hereinafter sometimes referred to as the composition) used in the present invention is not particularly limited as long as it contains a silicon containing polymer (I) and a solvent (II).

### (I) Silicon Containing Polymer

The silicon containing polymer (I) preferably comprises a polymer selected from the group consisting of polysilazane, polycarbosilazane, and polysiloxazane.

The mass average molecular weight of the silicon containing polymer (I) is preferably in the range from 3,000 to 30,000, more preferably in the range from 4,000 to 30,000, further preferably in the range from 4,000 to 25,000. In the present invention, the mass average molecular weight is a mass average molecular weight in terms of polystyrene, and can be measured by the gel permeation chromatography based on polystyrene.

The content of the silicon containing polymer (I) is preferably in the range from 0.50 to 40.0 mass %, more preferably in the range from 1.0 to 30.0 mass %, based on the total mass of the composition.

### Polysilazane

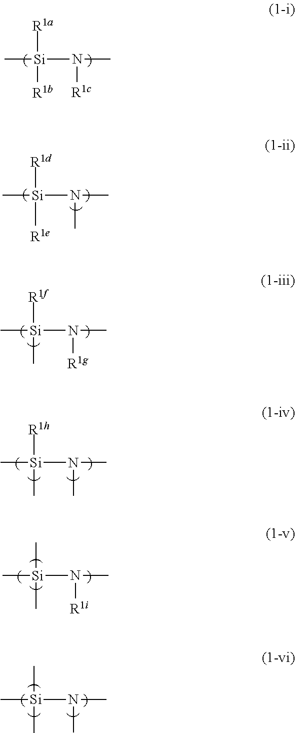

[symbol]

wherein, R^{1a} to R¹ⁱ are each independently hydrogen or C₁₋₄ alkyl.

More preferably, the polysilazane used in the present invention is perhydropolysilazane (hereinafter referred to as PHPS). PHPS is a silicon containing polymer comprising Si—N bond in a repeating unit and consisting only of Si, N and H. In this PHPS, except Si—N bond, all elements binding to Si and N are H, and any other elements such as carbon or oxygen are not substantially contained. The simplest structure of the perhydropolysilazane is a chain structure having a repeating unit of the following formula:

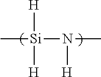

The structure of PHPS is not limited as long as it contains Si—N bonds in the repeating unit and is a silicon containing polymer consisting only of Si, N and H, and can take various structures other than those exemplified above. PHPS preferably has a cyclic structure or a crosslinked structure, particularly a crosslinked structure. The terminal group of the perhydropolysilazane is preferably —SiH₃.

The mass average molecular weight of the polysilazane is preferably in the range from 1,200 to 28,000, more preferably in the range from 1,500 to 25,000, from the viewpoint of solubility in solvents and reactivity.

### Polycarbosilazane

The structure of the polycarbosilazane used in the present invention is not particularly limited, and any polycarbosilazane can be optionally selected depending on the purpose. In the present invention, the polycarbosilazane has a C—Si—N structure.

In a preferable embodiment, the polycarbosilazane used in the present invention comprises a repeating unit represented by the following formula (2-i) and a repeating unit represented by the following formula (2-ii).

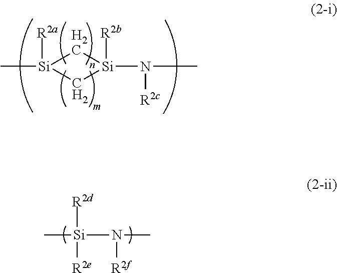

wherein,
R^{2a}, R^{2b} and R^{2c} are each independently a single bond, hydrogen or C₁₋₄ alkyl, preferably a single bond or hydrogen.
R^{2d}, R^{2e} and R^{2f} are each independently a single bond or hydrogen.

Provided that, when R^{2a}, R^{2b}, R^{2d} and R^{2e} are each independently single bond, they are bonded to N contained in other repeating units, and when R^{2c} and R^{2f} are each independently single bond, they are bonded to Si contained in other repeating units.

n and m are each independently in the range from 1 to 3, preferably 1 or 2, more preferably 1.

The polycarbosilazane is preferably polyperhydrocarbosilazane. The polyperhydrocarbosilazane is one, in which R^{2a}, R^{2b} and R^{2c} are single bonds or hydrogen and no hydrocarbon groups other than (CH₂)ₙ and (CH₂)ₘ in the formula (2-i) are included.

The terminal group of the polycarbosilazane is preferably —SiH₃.

The polycarbosilazane used in the present invention preferably consists substantially of the repeating unit represented by the formula (2-i) and the repeating unit represented by the formula (2-ii). In the present invention, “substantially” means that 95 mass % or more of all structural units contained in the polycarbosilazane are the repeating unit represented by the formula (2-i) and the repeating unit represented by the formula (2-ii). More preferably, the polycarbosilazane contains no repeating units other than the repeating unit represented by the formula (2-i) and the repeating unit represented by the formula (2-ii).

In another preferable embodiment, the polycarbosilazane used in the present invention comprises a repeating unit represented by the formula (2-iii):

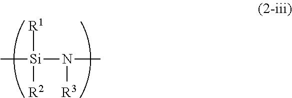

wherein,
R¹ and R² are each independently a single bond, hydrogen, C₁₋₄ alkyl or a linking group represented by the following formulae (a) to (c), preferably a single bond, hydrogen or a linking group represented by the formulae (a) to (c). When R¹ and R² are each independently single bond, they are bonded to N contained in other repeating units, and at least two of R¹ and R² in the molecule are linking groups represented by the formulae (a) to (c).
R³ is a single bond, hydrogen, or C₁₋₄ alkyl, preferably a single bond or hydrogen. When R³ is a single bond, it is bonded to Si contained in another repeating unit.

The linking group represented by the formula (a) is as follows:

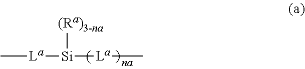

wherein,
R^{a} is each independently hydrogen, C₁₋₆ alkyl, C₁₋₆ alkenyl or C₆₋₁₂ aryl, preferably methyl, ethyl, vinyl, allyl, or phenyl.
L^{a} is each independently C₂₋₈ alkylene or C₆₋₁₄ arylene, preferably C₂₋₆ alkylene, more preferably —CH₂—CH₂— or —CH₂—CH₂—CH₂—. Methylene in the alkylene and the arylene is unreplaced or replaced with oxy, preferably unreplaced. However, when replaced with oxy, the oxy does not directly bond to Si in the formula (2-iii).
na is in the range from 1 to 3, preferably 2 or 3, more preferably 3.

Among the bonds of the linking group of the formula (a), the bonds that are not bonded to Si of the formula (2-iii) are bonded to Si contained in other repeating units.

The linking group represented by the formula (b) is as follows:

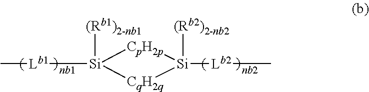

wherein,
R^{b1} and R^{b2} are each independently hydrogen, C₁₋₆ alkyl, C₁₋₆ alkenyl or C₆₋₁₂ aryl, preferably hydrogen or methyl.
L^{b1} and L^{b2} are each independently C₂₋₈ alkylene or C₆₋₁₄ arylene, preferably C₂₋₆ alkylene, more preferably —CH₂—CH₂— or —CH₂—CH₂—CH₂—. Methylene in the alkylene and the arylene is unreplaced or replaced with oxy, preferably unreplaced. Provided that when replaced with oxy, the oxy does not directly bond to Si in the formula (2-iii).
nb1 and nb2 are each independently in the range from 1 to 2, preferably 2.
p and q are each independently in the range from 1 to 3, preferably 1 or 2, and more preferably 1.

Among the bonds of the linking group of the formula (b), the bonds that are not bonded to Si of the formula (2-iii) are bonded to Si contained in other repeating units.

The linking group represented by the formula (c) is as follows:

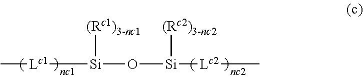

wherein,
R^{c1} and R^{c2} are each independently hydrogen, C₁₋₆ alkyl, C₁₋₆ alkenyl or C₆₋₁₂ aryl, preferably C₁₋₆ alkyl, more preferably methyl or ethyl.
L^{c1} and L^{c2} are each independently C₂₋₈ alkylene or C₆₋₁₄ arylene, preferably C₂₋₆ alkylene, more preferably —CH₂—CH₂— or —CH₂—CH₂—CH₂—. Methylene in the alkylene and the arylene is unreplaced or replaced with oxy, preferably unreplaced. Provided that when replaced with oxy, the oxy does not directly bond to Si in the formula (2-iii).
nc1 and nc2 are each independently in the range from 1 to 3, preferably 2.

Among the bonds of the linking group of the formula (c), the bonds that are not bonded to Si of the formula (2-iii) are bonded to Si contained in other repeating units.

The mass average molecular weight of the polycarbosilazane according to the present invention is preferably larger in order to prevent vaporization of low molecular weight components and suppress changes in volume when filled in fine trenches. On the other hand, a low viscosity is preferable for good coatability, and good filling even in trenches with high aspect ratio. For these reasons, the mass average molecular weight of the polycarbosilazane is preferably in the range from 1,200 to 28,000, more preferably in the range from 1,500 to 25,000.

### Polysiloxazane

The structure of the polysiloxazane used in the present invention is not particularly limited, and any polysiloxazane can be optionally selected depending on the purpose. The polysiloxazane has a siloxane bond in the polysilazane main skeleton, and preferably comprises a repeating unit represented by the following formula (3-i) and a repeating unit represented by the following formula (3-ii).

That is a siloxazane compound having repeating units represented below:

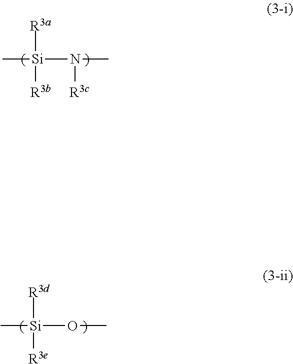

wherein,
R^{3a}, R^{3b}, R^{3c}, R^{3d} and R^{3e} are each independently a hydrogen atom, an alkyl group, an alkenyl group, a cycloalkyl group or an aryl group, at least one of R^{3a} and R^{3b} is a hydrogen atom, and at least one of R^{3d} and R^{3e} is a hydrogen atom.

In the siloxazane compound, the ratio of O atoms to the total number of O atoms and N atoms is 5% or more and 25% or less, and
in the spectrum of the siloxazane compound obtained by ²⁹Si-NMR based on the inverse gate decoupling method, the ratio of the peak area detected in the range from −75 ppm to −90 ppm to the peak area detected in the range from −25 ppm to −55 ppm is 4.0% or less.

The mass average molecular weight of the polysiloxazane according to the present invention is preferably larger in order to prevent vaporization of low molecular weight components and suppress changes in volume when filled in fine trenches. On the other hand, a low viscosity is preferable for good coatability, and good filling even in trenches with high aspect ratio. For these reasons, the mass average molecular weight of the polysiloxazane is preferably in the range from 1,200 to 28,000, more preferably in the range from 1,500 to 25,000.

### (II) Solvent

The solvent (II) comprises a solvent (II-A) with a relative evaporation rate S1 (hereinafter sometimes referred to as the solvent (II-A)) and a solvent (II-B) with a relative evaporation rate S2 (hereinafter sometimes referred to as the solvent (II-B)); wherein S1>S2, provided that the evaporation rate of n-butyl acetate measured at 25° C. and 1 atm. according to ASTM-D3539 is 1.

S1/S2 is in the range from 3.0 to 35.0, preferably in the range from 3.0 to 30.0, further preferably in the range from 3.5 to 30.0.

When the solvent (II) satisfies the above conditions, a conformal film can be formed. Although not to be bound by theory, evaporation proceeds from the good solvent with a high relative evaporation rate during spin coating. The silicon containing polymer becomes insolubilized in the poor solvent before the solvent is completely dried. The silicon containing polymer loses fluidity at a state of high polymer concentration. As a result, deposition of the composition onto the substrate is progressed to form a film.

The solvent (II) are not particularly limited as long as they satisfy the above conditions. Examples thereof include hydrocarbon solvents, ether solvents, ester solvents, alcohol solvents, ketone solvents, and the like. Specifically, they include n-dodecane (0.03), n-dibutyl ether (0.80), cyclohexanone (0.30), n-decane (0.19), propylene glycol monomethyl ether acetate (0.29), xylene (0.47), methyl isobutyl ketone (1.89), ethylcyclohexane (1.32), n-octane (1.66), toluene (1.31), methylcyclohexane (3.34), n-heptane (4.22), cyclohexane (4.61), methyl ethyl ketone (6.79), tetrahydrofuran (7.92), n-hexane (9.73), dichloromethane (18.6), and the like. The relative evaporation rate is shown in the parentheses. This value can be calculated by the following calculation formula:

Relative evaporation rate (provided that it is 1 for n-butyl acetate)=0.046×molecular volume (cm³/mol)×vapor pressure (mmHg).

This calculation formula is described in “S. Abbott, C. M. Hansen, H. Yamamoto, R. S. Valpey, Hansen Solubility Parameters in Practice Complete with ebook, software and data, 4th Edition, Hansen Solubility.com, 2013, ISBN 978-0-9551220-2-6”.

Preferably, the solvent (II-A) with relative evaporation rate S1 is a good solvent for the silicon containing polymer (I). Preferably, the solvent (II-B) with relative evaporation rate S2 is a poor solvent for the silicon containing polymer (I). More preferably, the solvent (II-A) with the relative evaporation rate S1 is a good solvent for the silicon containing polymer (I), and at the same time the solvent (II-B) with the relative evaporation rate S2 is a poor solvent for the silicon containing polymer (I).

In the present invention, provided that the HSP distance derived from the Hansen solubility parameter (HSP) for the silicon containing polymer (I) (HSP distance={4(dD₁−dD₂)²+(dP₁−dP₂)²+(dH₁−dH₂)²}^{0.5}, in which dD: dispersion term, dP: polar term, dH: hydrogen bond term; and in the case of the silicon containing polymer: dD₂: 20.2, dP₂: 10.0, dH₂: 4.6) is less than 13.6, the solvent is a good solvent, and provided that it is 13.6 or higher, the solvent is a poor solvent.

Examples of the solvent (II-A) include n-dibutyl ether (HSP distance: 12.06), dipropyl ether (HSP distance: 12.34), ethylcyclohexane (HSP distance: 13.51), dichloromethane (HSP distance: 7.38), cyclohexanone (HSP distance: 5.08), methyl ethyl ketone (HSP distance: 8.47), tetrahydrofuran (HSP distance: 8.73), toluene (HSP distance: 10.00), xylene (HSP distance: 10.31), methyl isobutyl ketone (HSP distance: 10.56), and the like.

Examples of the solvent (II-B) include n-decane (HSP distance: 14.22), n-dodecane (HSP distance: 13.85), n-octane (HSP distance: 14.47), n-hexane (HSP distance: 15.28), n-heptane (HSP distance: 14.74), and the like.

Examples of preferable combination of the solvent (II-A)/the solvent (II-B) include n-dibutyl ether/n-decane, n-dibutyl ether/n-dodecane, ethylcyclohexane/n-decane, dichloromethane/n-octane, propylene glycol monomethyl ether acetate/n-dodecane, methylcyclohexane/n-decane, and the like.

The content of the solvent (II-A) is preferably in the range from 20 to 90 mass %, more preferably in the range from 20 to 87 mass %, based on the total mass of the solvent (II).

The content of the solvent (II-B) is preferably in the range from 10 to 80 mass %, more preferably in the range from 13 to 80 mass %, based on the total mass of the solvent (II).

The solvent (II) may contain a solvent other than the solvent (II-A) and the solvent (II-B) (hereinafter sometimes referred to as the solvent (II-C)). The content of the solvent (II-C) is preferably in the range from 0 to 20 mass %, more preferably in the range from 0 to 10 mass %. It is also a preferable embodiment of the present invention that no solvent (II-C) is contained.

The content of the solvent (II) is preferably in the range from 60.0 to 99.5 mass %, more preferably in the range from 70.0 to 99.0 mass %, based on the total mass of the composition.

The composition used in the present invention can be combined with additional optional components. Examples of the optional component include surfactants. The content of the optional components excluding the solvent in the entire composition is preferably 5 mass % or less, more preferably 2 mass % or less, based on the total mass. It is also a preferable embodiment that the composition used in the present invention contains no optional components.

The present invention is described below with reference to Examples. These Examples are for explanation and do not intend to limit the scope of the present invention.

In the following Examples, the mass average molecular weight (Mw) is measured by the gel permeation chromatography (GPC) based on polystyrene. GPC is measured using Alliance (trademark) e2695 type high-speed GPC system (Nihon Waters K.K.) and an organic solvent-based GPC column Shodex KF-805L (Resonac Corporation). The measurement is conducted using monodispersed polystyrene as a standard sample and chloroform as an eluent, under the measuring conditions of a flow rate of 0.6 ml/min and a column temperature of 40° C., and then Mw is calculated as a relative molecular weight to the standard sample.

### Preparation of Polysilazane Intermediate A

After replacing the inside of a 10 L reaction vessel equipped with a cooling condenser, a mechanical stirrer and a temperature controller with dry nitrogen, 7,500 ml of dry pyridine is added into the reaction vessel and cooled up to −3° C. 500 g of dichlorosilane is added to form a white solid reaction mixture (SiH₂Cl₂·2C₅H₅N). After confirming that the reaction mixture is cooled to −3° C. or lower, 350 g of ammonia is slowly blown into it while stirring. Subsequently, after continuing to stir for 30 minutes, dry nitrogen is blown into the liquid layer for 30 minutes to remove excess ammonia. The resulting slurry product is subjected to pressure filtration using a 0.2 μm filter made from fluororesin under a dry nitrogen atmosphere to obtain 6,000 ml of a filtrate. Pyridine is distilled off using an evaporator, and xylene is added to obtain a xylene solution containing 39.8 mass % of polysilazane intermediate A. The Mw of the polysilazane intermediate A obtained is 1,200.

### Preparation of Silicon Containing Polymer A

4,680 g of dry pyridine, 180 g of dry xylene and 1,650 g of the xylene solution containing 39.8 mass % of the polysilazane intermediate A obtained above are charged into a 10 L reaction vessel equipped with a cooling condenser, a mechanical stirrer and a temperature controller, and the mixture is stirred while bubbling with dry nitrogen at a rate of 0.5 NL/min to be made uniformed. A modification reaction is carried out at 100° C. for 10.0 hours, and after distilling off pyridine, xylene is added to obtain a solution containing 40.5 mass % of polysilazane (hereinafter sometimes referred to as the silicon containing polymer A). The Mw of the silicon containing polymer A obtained is 7,500.

### Preparation of Silicon Containing Polymer B

After replacing the inside of a 1 L reaction vessel equipped with a cooling condenser, a mechanical stirrer and a temperature controller with dry nitrogen, 500 ml of dry pyridine is charged into the reaction vessel and cooled up to −3° C. Thereafter, 9.85 g of dichlorosilane and 4.38 g of 1,1,3,3-tetrachloro-1,3-disilacyclobutane are added. After confirming that the temperature of the reaction mixture is cooled to 0° C. or lower, 10.3 g of ammonia is slowly blown into the reaction mixture while stirring. Subsequently, after continuing to stir for 30 minutes, dry nitrogen is blown into the liquid layer for 30 minutes to remove excess ammonia. The resulting slurry product is subjected to pressure filtration under a dry nitrogen atmosphere using a 0.2 μm filter made of fluororesin to obtain 400 ml of a filtrate. After distilling off the pyridine from the filtrate, xylene is added to obtain a solution containing 40.8 mass % of polycarbosilazane B (hereinafter sometimes referred to as the silicon containing polymer B). The Mw of the silicon containing polymer B obtained is 9,100.

### Preparation of Silicon Containing Polymer C

In a 200 mL three-necked flask equipped with a magnetic stirrer bar, a nitrogen inlet and a reflux condenser, 30.0 g of the polysilazane intermediate A in xylene, 0.80 g of tetravinylsilane as a crosslinker in 8 g of toluene and 0.65 g of azabisisobutyronitrile (AIBN) as a reaction initiator are added, and xylene is further added so that the content of the polysilazane intermediate A is 20 mass %, thereby preparing a reaction solution. While stirring, dry nitrogen is blown into this for 10 minutes (50 mL/min). Thereafter, it is heated at 75° C. for 5 hours and concentrated at 40° C. under reduced pressure to obtain a solution containing 41.0 mass % of polycarbosilazane C (hereinafter sometimes referred to as the silicon containing polymer C). The Mw of the silicon containing polymer C obtained is 11,800.

### Preparation of Silicon Containing Polymer D

After replacing the inside of a 10 L reaction vessel equipped with a cooling condenser, a mechanical stirrer and a temperature controller with dry nitrogen, 2,800 g of dry pyridine and 400 g of a xylene solution containing 39.8 mass % of the polysilazane intermediate A are introduced, and the mixture is cooled up to −5° C. while stirring. Hydrous pyridine prepared by dissolving 6 g of pure water in 1,000 g of dry pyridine is added dropwise to the mixed solution cooled to −5° C. over 3 hours with stirring. After dropping, the solution is returned to room temperature and further stirred for one hour. After distilling off the pyridine, xylene is added to obtain a solution containing 18.5 mass % of polysiloxazane (hereinafter sometimes referred to as the silicon containing polymer D). The Mw of the silicon containing polymer D obtained is 5,400.

### Example 1

The solvent is distilled off from 20 g of a solution containing 40.5 mass % of the silicon containing polymer A, and 184.4 g of n-dibutyl ether and 78.5 g of n-decane are added to obtain 3.0 mass % of a cured film forming composition A.

The cured film forming composition A is dropped onto a silicon wafer (8 inches) having a trench (width: 2 μm, length: 20 μm, and depth: 13 μm), spin-coated at a rotation speed of 1,000 rpm, and subjected to spin drying for 90 seconds at a rotation speed of 2,000 rpm to form a coating film. Prebaking is performed on a hot plate at 200° C. for 180 seconds in a dry nitrogen atmosphere to dry the coating film and form a conformal film. Using a heat diffusion furnace, the conformal film is heated at 400° C. for 30 minutes in an 80% steam atmosphere (the remainder being O₂), and then annealed at 800° C. for 30 minutes in a dry nitrogen atmosphere to obtain a cured film.

### Examples 2 to 6, Comparative Examples 1 to 3

In the same manner as in Example 1, compositions are prepared with the compositions changed as shown in Tables 1 to 3. Using them, coating films are formed and dried in the same manner as in Example 1. The heating conditions thereafter are changed as shown in Tables 1 to 3 to obtain cured films.

TABLE 1
Table 1

| | | Example 1 | | Example 2 | | Example 3 | |
|---|---|---|---|---|---|---|---|
| | | | Content | | Content | | Content |
| | | Type | (mass %) | Type | (mass %) | Type | (mass %) |
| Composition | (I) | silicon containing | 3 | silicon containing | 3 | silicon containing | 3 |
| | | polymer A | | polymer A | | polymer A | |
| | (II-A) | n-dibutyl ether | 68 | n-dibutyl ether | 41 | n-dibutyl ether | 27 |
| | (II-B) | n-decane | 29 | n-decane | 56 | n-decane | 70 |
| | Total | — | 100 | — | 100 | — | 100 |

| | | | |
|---|---|---|---|
| S1/S2 | 4.2 | 4.2 | 4.2 |

| | | | |
|---|---|---|---|
| Curing step | 400° C./steam/30 min | 400° C./steam/30 min | 400° C./steam/30 min |
| (temperature/atmosphere/ | ↓ | ↓ | ↓ |
| time) | 800° C./N₂/30 min | 800° C./N₂/30 min | 800° C./N₂/30 min |
| Refractive index | 1.44 | 1.44 | 1.44 |
| Conformality | A | A | A |

TABLE 2
Table 2

| | | Example 4 | | Example 5 | | Example 6 | |
|---|---|---|---|---|---|---|---|
| | | | Content | | Content | | Content |
| | | Type | (mass %) | Type | (mass %) | Type | (mass %) |
| Composition | (I) | silicon containing | 23 | silicon containing | 3 | silicon containing | 3 |
| | | polymer B | | polymer C | | polymer D | |
| | (II-A) | n-dibutyl ether | 67 | ethylcyclohexane | 57 | dichloromethane | 22 |
| | (II-B) | n-dodecane | 10 | n-decane | 40 | n-octane | 75 |
| | Total | — | 100 | — | 100 | — | 100 |

| | | | |
|---|---|---|---|
| S1/S2 | 28.9 | 7.0 | 11.2 |

| | | | |
|---|---|---|---|
| Curing step | 400° C./steam/30 min | 400° C./steam/30 min | 400° C./steam/30 min |
| (temperature/atmosphere/ | ↓ | ↓ | ↓ |
| time) | 800° C./N₂/30 min | 800° C./N₂/30 min | 800° C./N₂/30 min |
| Refractive index | 1.46 | 1.47 | 1.44 |
| Conformality | A | A | A |

TABLE 3
Table 3

| | | Comparative Example 1 | | Comparative Example 2 | | Comparative Example 3 | |
|---|---|---|---|---|---|---|---|
| | | | Content | | Content | | Content |
| | | Type | (mass %) | Type | (mass %) | Type | (mass %) |
| Composition | (I) | silicon containing | 3 | silicon containing | 3 | silicon containing | 3 |
| | | polymer A | | polymer A | | polymer A | |
| | (II-A) | n-dibutyl ether | 97 | dichloromethane | 27 | n-dibutyl ether | 41 |
| | (II-B) | — | | n-decane | 70 | n-octane | 56 |
| | Total | — | 100 | — | 100 | — | 100 |

| | | | |
|---|---|---|---|
| S1/S2 | — | 98.4 | 0.48 |

| | | | |
|---|---|---|---|
| Curing step | 400° C./steam/30 min | 400° C./steam/30 min | 400° C./steam/30 min |
| (temperature/atmosphere/ | ↓ | ↓ | ↓ |
| time) | 800° C./N₂/30 min | 800° C./N₂/30 min | 800° C./N₂/30 min |
| Refractive index | 1.44 | 1.44 | 1.44 |
| Conformality | C | C | B |

### S1/S2

S1/S2 in the tables are calculated using the following relative speed values.

TABLE 4
Table 4

| | |
|---|---|
| n-dibutyl ether | 0.80 |
| n-decane | 0.19 |
| n-dodecane | 0.03 |
| ethylcyclohexane | 1.32 |
| n-octane | 1.66 |
| dichloromethane | 18.6 |

### Refractive Index

The refractive indices of the non-trenched portions of the silicon wafer (8 inches) on which the cured films of Examples 1 to 6 and Comparative Examples 1 to 3 are formed are measured using a spectroscopic ellipsometer M-2000V (J. A. Woollam). The results obtained are described in Tables 1 to 3.

### Evaluation of Conformality

After the substrate on which the above cured film is formed is returned to the environment of room temperature, it is cut perpendicularly to the trench, the fractured surface is observed with an electron microscope, and evaluated according to the following criteria. The results obtained are described in Tables 1 to 3.
A: Formation of a highly conformal cured film is observed in the trench.
B: No formation of a cured film is observed on the side surfaces of the trench.
C: The trench is filled with a cured film.

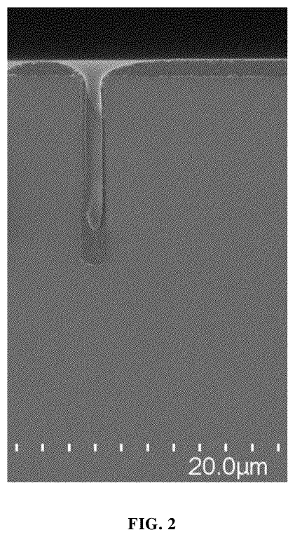

FIG. 2 is a cross-sectional electron micrograph of the trench of Example 1. From FIG. 2, it can be seen that in Example 1, a highly conformal cured film is formed in the trench.

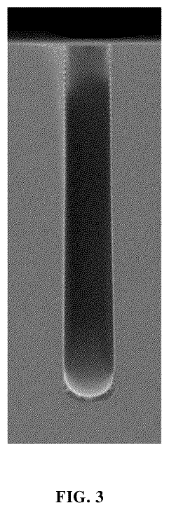

FIG. 3 is a cross-sectional electron micrograph of the trench of Comparative Example 3. From FIG. 3, it can be seen that in Comparative Example 3, a cured film is formed on the bottom of the trench, but no cured film is formed on the sides of the trench.

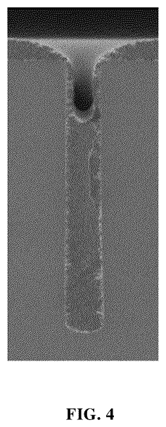

FIG. 4 is a cross-sectional electron micrograph of the trench of Comparative Example 2. From FIG. 4, it can be seen that in Comparative Example 2, the trench is filled with the cured film.

What is claimed is:

1. A method for manufacturing a silicon containing conformal cured film, comprising:
(a) applying a cured film forming composition comprising a silicon containing polymer (I) and a solvent (II) to a substrate;
(b) forming a conformal film by drying the composition; and
(c) curing the conformal film by heating the substrate and/or irradiating the substrate with energy rays;
wherein the solvent (II) comprises a solvent (II-A) with a relative evaporation rate S1 and a solvent (II-B) with a relative evaporation rate S2;
wherein S1>S2; and
S1/S2 is in the range from 3.0 to 35.0, provided that the evaporation rate of n-butyl acetate measured at 25° C. and 1 atm according to ASTM-D3539 is 1.

2. The method according to claim 1, wherein the silicon containing polymer (I) comprises a polymer selected from the group consisting of polysilazane, polycarbosilazane, and polysiloxazane.

3. The method according to claim 2, wherein the mass average molecular weight of the silicon containing polymer (I) is in the range from 3,000 to 30,000.

4. The method according to claim 2, wherein the content of the silicon containing polymer (I) is in the range from 0.5 to 40 mass % based on the total mass of the cured film forming composition.

5. The method according to claim 1, wherein the silicon containing polymer is better dissolved in solvent (II-A) than in solvent (II-B).

6. The method according to claim 1, wherein the content of the solvent (II-A) with the relative evaporation rate S1 is in the range from 20 to 90 mass % based on the total mass of the solvent (II).

7. The method according to claim 1, wherein the drying in the step (b) is performed by spin drying.

8. The method according to claim 1, wherein the drying in the step (b) is performed under reduced pressure.

9. The method according to claim 1, wherein the heating in the step (c) is performed at a temperature in the range from 300 to 1,000° C.

10. The method according to claim 1, wherein the energy ray irradiation in the step (c) is performed at a peak wavelength in the range from 100 to 250 nm.

11. A silicon containing conformal cured film obtained by the method according to claim 9.

12. A silicon containing conformal cured film obtained by the method according to claim 10.

13. A method for manufacturing an electronic device comprising the method according to claim 1.
